(19) United States
(12) Patent Application Publication
(10) Pub. No.: US 2022/0306450 A1
(43) Pub. Date: Sep. 29, 2022

(54) HORSE RIDING SADDLE

(71) Applicant: PRESTIGE ITALIA S.P.A., TRISSINO (IT)

(72) Inventor: Andrea RASIA, BROGLIANO, FRAZIONE QUARGNENTA (IT)

(21) Appl. No.: 17/620,023

(22) PCT Filed: Jun. 11, 2020
(86) PCT No.: PCT/EP2020/066222

§ 371 Date: Dec. 16, 2021

(30) Foreign Application Priority Data
Jun. 19, 2019 (IT) 102019000009414

(51) Int. Cl. B68C 1/02

(52) U.S. Cl. CPC B68C 1/02

(57) ABSTRACT

A horse riding saddle comprising a supporting frame, which defines a seat which extends along a longitudinal axis of the saddle, and at least one first flap and second flap, which are associated with the supporting frame and are arranged on opposite sides with respect to the longitudinal axis; the first and second flaps are stably associated, at a respective front resting portion, with a knee roll which defines a respective contact body for a portion of the leg of the user; the knee rolls define a coupling surface which is designed to be arranged so as to face a respective front resting portion of the flap and which comprises at least one portion which defines a concave surface which extends around an axis which is substantially parallel to the longitudinal axis of the saddle.

### TECHNICAL FIELD

The present disclosure relates to a horse riding saddle.

### BACKGROUND

In the sector of animal harness, the use is known of horse riding saddles which are adapted to be positioned on the back of a horse in order to make it more comfortable for the rider to sit during use.

Typically, horse riding saddles are constituted by a supporting frame or core, which defines a seat for the user, and a pair of lateral elements, commonly known as flaps, which are connected to the frame on opposite sides with respect to the seat.

The flaps define a resting region for the legs of the user, preventing direct contact between the legs and the flanks of the horse.

Both single-flap saddles and double-flap saddles, which have two overlaid lateral elements on each side, are provided with supporting knee rolls, which are padded front portions which are currently provided by way of molding from polyurethane material.

Knee rolls typically have a flat surface for coupling with the flap (or with the underflap), and a lateral surface of different size and shape which is adapted to define a contact for the leg of the user.

The conventional solutions, although widely used, are not however devoid of drawbacks.

In fact, at the end of the process of making saddles, it is found that the flaps and the pads do not follow the morphological structure of the horse.

As a consequence, before the saddle can adapt to the anatomy of the horse and can therefore function well, intense use of the materials and repeated pressure exerted by the leg of the rider are necessary.

Furthermore, supporting knee rolls are usually rigid, and therefore rather uncomfortable and not very adaptable to the leg of the rider.

### SUMMARY

The aim of the present disclosure is to provide a horse riding saddle which is capable of improving the known art in one or more of the above mentioned aspects.

Within this aim, the disclosure provides a horse riding saddle that is capable of adapting to the morphological structure of the horse.

The disclosure also provides a horse riding saddle that is highly reliable.

This aim and these and other advantages which will become better apparent hereinafter are achieved by providing a horse riding saddle according to claim 1, optionally provided with one or more of the characteristics of the dependent claims.

### BRIEF DESCRIPTION OF THE DRAWINGS

Further characteristics and advantages of the disclosure will become better apparent from the detailed description that follows of a preferred, but not exclusive, embodiment of a horse riding saddle according to the disclosure, which is illustrated for the purposes of non-limiting example in the accompanying drawings wherein:

FIG. 1 is a perspective view of a horse riding saddle according to the disclosure;

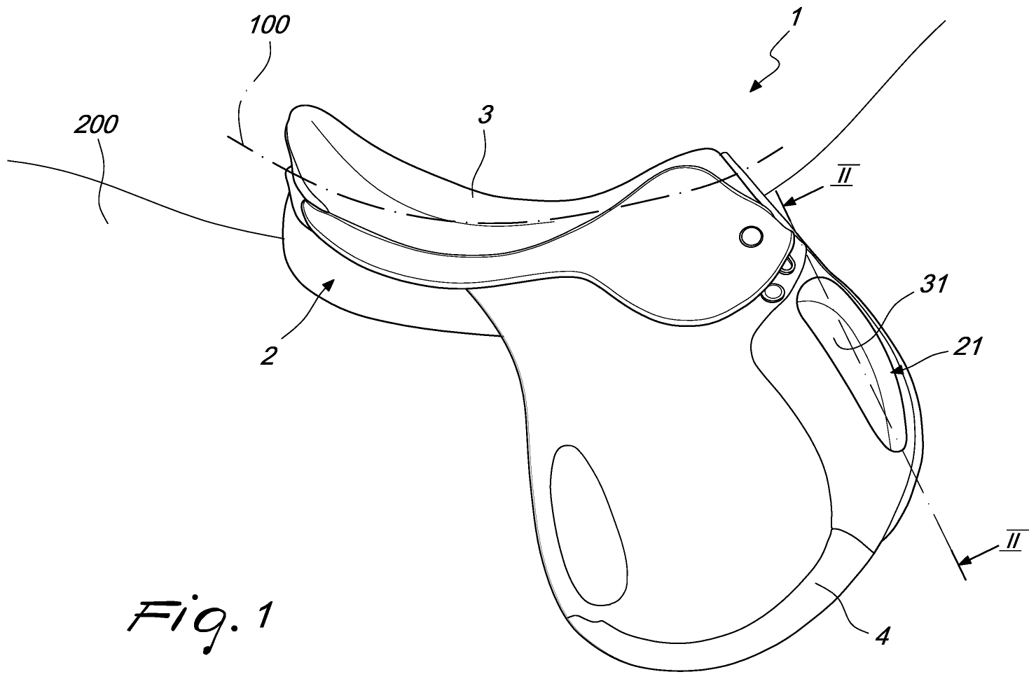

FIG. 2 is a cross-sectional view of the saddle along the plane of arrangement identified by the line II-II of FIG. 1; and

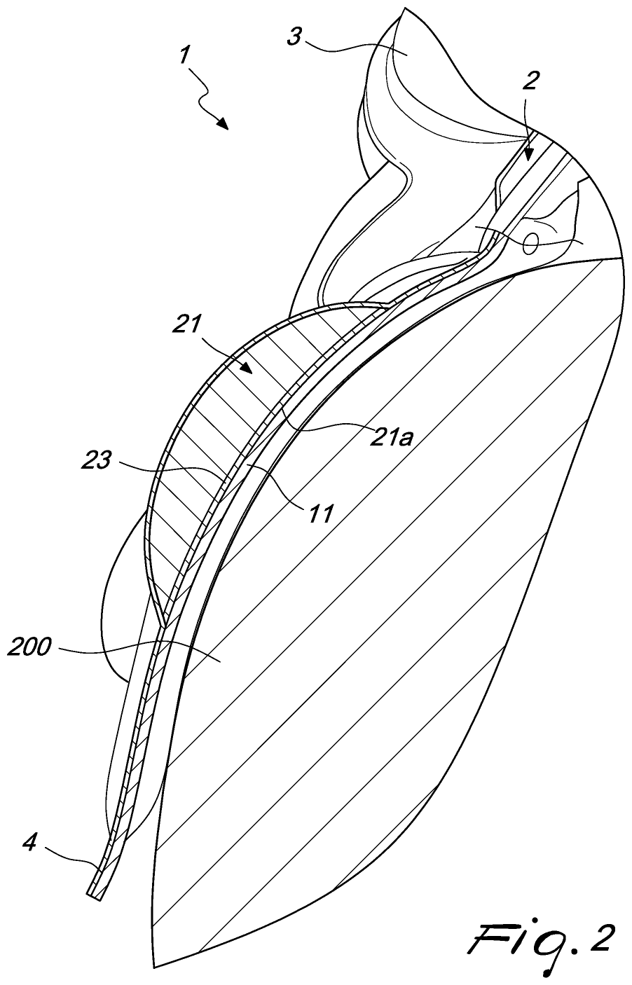

FIG. 3 is a transverse cross-sectional view of the horse riding saddle.

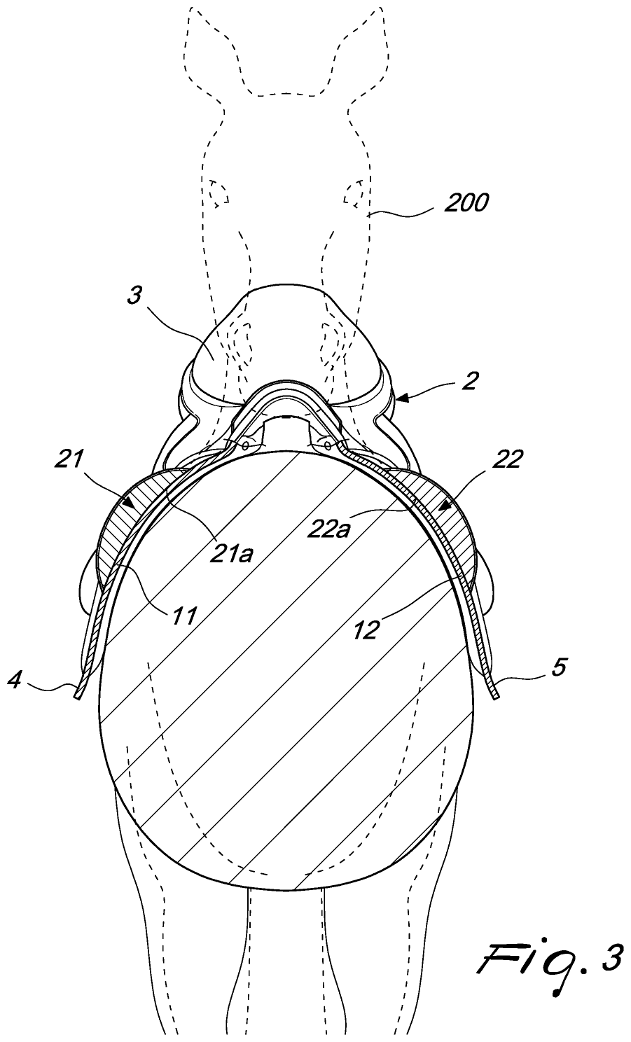

### DETAILED DESCRIPTION OF THE DRAWINGS

With reference to the figures, the horse riding saddle according to the disclosure, generally designated by the reference numeral 1, comprises a supporting frame 2, which defines a seat 3 which extends along a longitudinal axis 100 of the saddle 1, and at least one first flap and second flap 4, 5, which are associated with the supporting frame 2 and are arranged on opposite sides with respect to the longitudinal axis 100.

The first and second flaps 4, 5 are stably associated, at a respective front resting portion 11, 12, with a knee roll 21, 22 which defines a respective contact body 31, 32 for a portion of the leg of the user.

According to the present disclosure, the knee rolls 21, 22 define a coupling surface 21a, 22a which is designed to be arranged so as to face toward a respective front resting portion 11, 12 of the respective flap 4, 5.

In particular, the coupling surfaces 21a, 22a comprise at least one portion which has a concave surface which extends about an axis which is substantially parallel to the longitudinal axis 100 of the saddle 1.

In particular, the knee rolls 21, 22 originally have the respective coupling surface 21a, 22a that comprises at least one portion which has a concave surface which extends about an axis which is substantially parallel to the longitudinal axis 100 of the saddle 1.

The term “originally” is used to mean that such knee rolls 21, 22 already have the shape described above when they are associated with the respective flaps 4, 5, during the production of the saddle 1.

According to a first possible embodiment, the horse riding saddle 1 is constituted by a single-flap horse riding saddle.

In this case, the first flap and the second flap 4, 5 are constituted by the respective single flap.

Obviously, there is no reason why the horse riding saddle 1 cannot be constituted by a double-flap saddle.

In this case, the first flap and second flap 4, 5 which define the front resting portion 11, 12 with which to associate the knee rolls 21, 22 can be constituted indifferently by the underflap that is directed toward the back of the horse 200 or by the upper flap.

Preferably, the concave surface is contoured in a manner that substantially corresponds to the morphological structure of the back of the horse 200.

Conveniently, the knee rolls 21, 22 are made of polyurethane-based expanded material.

According to a preferred embodiment, the coupling surfaces 21a, 22a of the knee rolls 21, 22 have a reinforcement layer 23.

Advantageously, the reinforcement layer 23 is made of pressure-molded cellulose material.

Use of the horse riding saddle 1 according to the disclosure is evident from the foregoing description.

In practice it has been found that the disclosure fully achieves the intended aim and objects by providing a horse riding saddle 1 that originally has a coupling surface 21a, 22a which is concave in shape, so as to be immediately and optimally adapted to the body of the horse 200, without requiring a repeated pressure by the leg of the rider.

Furthermore, by virtue of the low density of the material used, the knee roll 21, 22 is extremely soft, and this appreciably increases the comfort and determines a greater capacity to adapt to the leg of the rider.

Finally, the optional presence of the reinforcement layer 23, for example in cellulose material, gives the support 11, 12 the rigidity necessary to maintain the concave shape.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102019000009414 from which this application claims priority are incorporated herein by reference.

1-8. (canceled)

9. A horse riding saddle comprising: a supporting frame, which defines a seat which extends along a longitudinal axis of the saddle, and at least one first flap and at least one second flap, which are associated with said supporting frame and are arranged on opposite sides with respect to said longitudinal axis, said first and second flaps being stably associated, at a respective front resting portion, with a knee roll which defines a respective contact body for a portion of a leg of a user, wherein each said knee roll has a coupling surface configured to be arranged to face a respective front resting portion of said flap and which comprises at least one portion which defines a concave surface extending around an axis substantially parallel to said longitudinal axis of said saddle.

10. The horse riding saddle according to claim 9, wherein said knee rolls have, when they are associated with the respective flaps, the respective coupling surface of each said knee roll that comprises at least one portion having a concave surface extending about an axis substantially parallel to said longitudinal axis of the saddle.

11. The horse riding saddle according to claim 9, further comprising a single-flap horse riding saddle, said first and second flaps comprising a respective flap.

12. The horse riding saddle according to claim 9, comprising a double-flap horse riding saddle, said first and second flaps comprising an underflap directed towards a back of the horse, or an upper flap.

13. The horse riding saddle according to claim 9, wherein said concave surface is shaped such that said concave surface substantially corresponds to a morphological structure of a back of a horse.

14. The horse riding saddle according to claim 9, wherein said knee rolls are made of polyurethane-based expanded material.

15. The horse riding saddle according to claim 9, wherein said coupling surfaces of said knee rolls have a reinforcement layer.

16. The horse riding saddle according to claim 15, wherein said reinforcement layer is made of pressure-molded cellulose material.
